(19) United States
(12) Patent Application Publication
(10) Pub. No.: US 2011/0206905 A1
(43) Pub. Date: Aug. 25, 2011

(54) METHOD FOR FORMING A BLOCK COPOLYMER PATTERN

(75) Inventors: Jillian Buriak, Edmonton (CA); Jinan Chai, Evanston, IL (US); Kenneth Harris, Edmonton (CA); Nathanael Wu, Edmonton (CA); Xiaojiang Zhang, Edmonton (CA)

(73) Assignees: The Governors of the University of Alberta, Edmonton (CA); National Research Council of Canada, Ottawa (CA)

(21) Appl. No.: 13/022,584

(22) Filed: Feb. 7, 2011

Related U.S. Application Data
(60) Provisional application No. 61/301,914, filed on Feb. 5, 2010.

(51) Int. Cl. B32B 3/30; B05D 1/36; B05D 5/00; B05D 3/00; B05D 3/10; C25D 5/54; B82Y 30/00; B82Y 40/00

(52) U.S. Cl. 428/172; 427/265; 427/261; 205/85; 427/535; 977/890

(57) ABSTRACT

A method for forming a block copolymer pattern on a substrate, wherein the areal density of nanostructures in the pattern is increased by increasing the thickness of the block copolymer film that is applied to the substrate.

### CROSS REFERENCE TO RELATED APPLICATIONS

This application claims the benefit of priority to corresponding U.S. Provisional Patent Application No. 61/301,914 filed Feb. 5, 2010, which is incorporated herein in its entirety.

### FIELD OF THE DISCLOSURE

The present disclosure relates to a method for forming a block copolymer pattern on a substrate.

### BACKGROUND OF THE DISCLOSURE

Patterning techniques based on block copolymers are often described as a potential means of surpassing the pattern resolution that may be achieved using conventional photolithography used in microfabrication. With block copolymer (BCP) patterning, a thin film of an appropriate block copolymer is cast onto a substrate, and chemical interactions between the polymer blocks induce the formation of a phase segregated nanostructure. Thin films with a thickness incorporating a single layer of phase separated polymer features are normally employed, and with block concentrations and anneal conditions appropriate to the formation of spherical micelles, a hexagonal lattice of polymer structures is formed on the surface. When polymer block concentrations and anneal conditions generate a cylindrical phase separation, an arrangement of parallel cylinders is formed in the thin film. The ultimate resolution (or minimum feature size) that can be formed is generally limited by thermodynamics and the selection of polymers available. Simple processing/handling techniques to increase the block copolymer feature density without redesigning the polymers potentially allow more devices to be packed on a given substrate, improving performance measures such as device density or cost effectiveness.

In the literature, the value of “density doubling” has been discussed. In one instance, a chemical pattern was printed on a substrate, and the block copolymer feature density of these chemically pre-patterned substrates was doubled, tripled or quadrupled, by choosing block-copolymers known to generate patterns with exact fractional decrements from the spacing of the chemical pre-pattern. This method, however, allows patterning of the block co-polymer with resolutions beyond that of the chemical pre-pattern, but does not increase the actual resolution of the polymer. No systems have currently been reported for increasing the feature density of the polymers themselves, nor have any methods for producing intermixed arrays of multiple materials.

Once formed, several methods exist for transferring the block copolymer pattern to the substrate or another material, including selective etching or selective chemical binding.

### SUMMARY OF THE DISCLOSURE

It has now been determined that the feature density of a block copolymer pattern on a substrate is increased by increasing the thickness of the film of block copolymer that is applied to the substrate.

Accordingly, the present disclosure relates to a method of forming a block copolymer pattern on a substrate, the method comprising:
contacting the substrate with a block copolymer under conditions for a phase segregated arrangement of the block copolymer and for at least a first layer and a second layer to be formed on the substrate, the first and second layers comprising a block copolymer pattern comprising nanostructures.

In another embodiment of the disclosure, the nanostructures in the first layer are interstitially spaced apart from the nanostructures in the second layer. In a further embodiment, at least three layers comprising nanostructures are formed on the substrate. In an embodiment, the nanostructures formed in each layer are interstitially spaced apart from the nanostructures in each adjacent layer.

In another embodiment, the nanostructure density on the substrate is between 50 nanostructures/μm² and 2000 nanostructures/μm², optionally between 150/μm² and 1500/μm², optionally between 400/μm² and 1200/μm².

In another embodiment of the disclosure, the spacing between adjacent nanostructures is between 1 nm and 500 nm, optionally between 10 nm and 100 nm, optionally between 20 nm and 60 nm, optionally between 25 nm and 50 nm.

In another embodiment, the nanostructures of the block copolymer pattern comprise micelles in the shape of nanodots or nanolines. In a further embodiment, spherical micelles in the block copolymer form a rectangular or hexagonal array pattern in the block copolymer pattern. In another embodiment, nanolines in the block copolymer pattern form nanowires or nanocylinders.

In an embodiment of the disclosure, the block copolymer is a diblock copolymer. In a further embodiment, the diblock copolymer comprises functional groups that bind to a metal salt.

In another embodiment of the disclosure, the diblock copolymer is a polymer of the formula (I):

A-B (I)

wherein A is a repeating polymeric monomer unit of the formula (II)

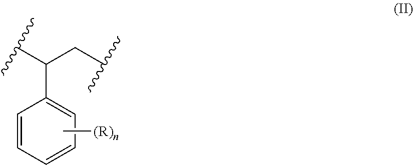

wherein each R is independently or simultaneously selected from H, halo, (C₁-C₆)-alkyl, —O—(C₁-C₆)-alkyl or fluoro-substituted-(C₁-C₆)-alkyl,
n is 1, 2, 3, 4 or 5; and
B is a repeating polymeric monomer unit of the formula (III)

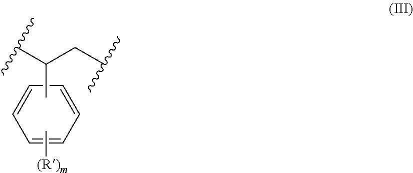

wherein each R′ is independently or simultaneously selected from H, halo, (C₁-C₆)-alkyl, —O—(C₁-C₆)-alkyl or fluoro-substituted-(C₁-C₆)-alkyl, and
m is 1, 2, 3 or 4.

In another embodiment, A is

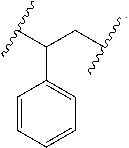

In a further embodiment, B is

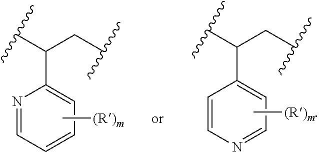

wherein each R′ is independently or simultaneously selected from H, halo, (C₁-C₆)-alkyl, —O—(C₁-C₆)-alkyl or fluoro-substituted-(C₁-C₆)-alkyl, and m is 1, 2, 3 or 4. In another embodiment, B is

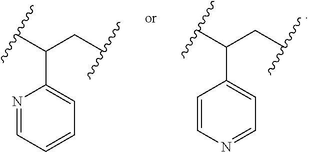

In another embodiment of the disclosure, the block copolymer comprises polystyrene-block-polyvinylpyridine (PS-b-PVP), polystyrene-block-polydimethylsiloxane (PS-b-PDMS), polystyrene-block-polyethyleneoxide (PS-b-PEO), polyethyleneoxide-block-polyisoprene (PEO-b-PI), polyethyleneoxide-block-polybutadiene (PEO-b-PBD), polyethyleneoxide-block-polymethylmethacrylate (PEO-b-PMMA), polyethyleneoxide-block-polyvinylpyridine (PEO-b-PVP), polystyrene-block-polymethylmethacrylate (PS-b-PMMA), polyvinyl pyridine-block-polymethyl methacrylate (PVP-b-PMMA), polyethyleneoxide-block-polyethylethylene (PEO-b-PEE), polystyrene-block-polybutadiene (PS-b-PBD), styrene-isoprene-styrene (SIS), or polybutadiene-block-polyvinylpyridine (PBD-b-PVP). In another embodiment, the disclosure also comprises block copolymer films including diblock, triblock and multiblock copolymers or blends of several block copolymers. One skilled in the art will understand that it is possible to synthesize and organize many different block copolymers, and that the substitution of a block copolymer not listed above does not constitute a departure from the disclosure.

In another embodiment of the disclosure, the substrate comprises silicon (Si), gallium arsenide (GaAs), germanium (Ge), another semiconductor, a metal, indium tin oxide, or a plastic. In another embodiment of the disclosure, the substrate comprises silicon, GaAs, Ge, a semiconductor, a metal, indium tin oxide, or a plastic.

In another embodiment, there is also included a method of forming a metallic nanostructure array comprising:
(i)
   (a) contacting the block copolymer coated substrate according to the above disclosure with a metal salt comprising metal ions under conditions for the metal ions to bind to the nanostructures; and
   (b) subsequently treating the substrate obtained in (a) to remove the block copolymer from the substrate and to form a metallic nanostructure array corresponding to the block copolymer pattern; or
(ii)
   (a) treating the block copolymer coated substrate with a metal salt under conditions for the galvanic displacement and deposition of the metal; and
   (b) subsequently removing the block copolymer to form a metallic nanostructure array corresponding to the block copolymer pattern.

In a further embodiment of the disclosure, the block copolymer coated substrate is contacted with a first metal salt and subsequently contacted with a second metal salt. In another embodiment, the first and second metal salts are independently selected from CoCl₂, ZnCl₂, Na₂PtCl₄, Na₂PdCl₄, RhCl₃, AgNO₃ and HAuCl₄. In a further embodiment, the metal ion is Co²⁺, Zn²⁺, PtCl₄²⁻, PdCl₄², Rh³⁺, Ag⁺ and/or AuCl₄⁻. In another embodiment, each layer of the block copolymer pattern is contacted with more than one metal salt, for example two metal salts, to form metal alloys, or core-shell metal complexes, in each independent layer.

In another embodiment, the substrate is treated with plasma, such as oxygen plasma, to remove the block copolymer from the substrate.

In another embodiment, the BCP-coated substrate is treated with a first metal salt, then exposed to a plasma to reduce the metal ions and partially remove the polymer. Subsequently, the substrate is treated with a second metal salt, and exposed to a second plasma process to reduce the second metal ions and completely remove the polymer.

In another embodiment, a metallic nanostructure array is formed using galvanic displacement, in which metallic nanostructures are directly formed during the galvanic displacement process. In this embodiment, the block copolymer is removed by dissolving the polymer on the substrate using an organic solvent, such as toluene or tetrahydrofuran (THF).

In another embodiment, the method further comprises selectively etching the organized BCP-coated substrate such that the BCP is treated with an etchant that selectively attacks one of the blocks. In an embodiment, the etching removes one block and exposes the substrate underneath only that block. In another embodiment, after this, the exposed areas are attacked with a different chemical.

In another embodiment of the disclosure, the multilayer BCP film is selectively etched by ozone treatment or reactive ion etching. In another embodiment, the BCP is PS-b-PBD, the substrate is silicon nitride, and the organized multilayer PS-b-PBD film is first ozonated, then etched by reactive ion etching to produce a silicon nitride film with a pattern of holes (see for example Park, et al., Science, 276, 1401 (1997)). In another embodiment, the BCP is PS-b-PBD, the substrate is silicon nitride, and the organized multilayer PS-b-PBD film is first stained with an osmium dye, then etched by reactive ion etching to produce a pattern on the silicon nitride.

In a further embodiment, the block copolymer pattern is transferred into an alternate material by treatment with nanoparticles (see for example, Kashem et al., Macromolecules, 42, 6202 (2009)). In a further embodiment, the BCP is PS-b-PMMA and an amount of iron oxide nanoparticles are mixed with the BCP film. The nanoparticles selectively bind to the PMMA block and assume the organization of the PMMA component within the block copolymer film.

The present disclosure is also directed to a substrate comprising a nanostructure array produced in accordance with the method of the present disclosure.

In another embodiment, the substrate comprising a nanostructure array produced in accordance with the present disclosure is used as a nanostructured battery.

In another embodiment, the substrate comprising a nanostructure array produced in accordance with the present disclosure is used as a nanostructured solar cell.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

The present disclosure will now be described in greater detail with reference to the attached drawings in which:

FIG. 1 is a schematic diagram showing a nanoparticle array in an embodiment of the present disclosure from (a) a side perspective, and (b) a top perspective;

FIG. 2 shows a micrograph showing a nanoparticle array produced where (a) the block copolymer pattern comprises a single layer, and (b) in accordance with an embodiment of the present disclosure, the block copolymer pattern comprises two layers;

FIG. 3 shows a micrograph of a hexagonal nanoparticle array formed using an embodiment of the process of the present disclosure;

FIG. 4 shows a micrograph of a nanoline array formed using an embodiment of the process of the present disclosure;

FIG. 5 shows a micrograph of a nanoline pattern formed using an embodiment of the process of the present disclosure;

FIG. 6 shows a micrograph demonstrating the effect of the degree of swelling on BCP features in an embodiment of the process of the present disclosure;

FIG. 7 shows a micrograph demonstrating the effect of annealing time on BCP features in an embodiment of the process of the present disclosure;

FIG. 8 shows a micrograph demonstrating the effect of relaxation rate on BCP features in an embodiment of the process of the present disclosure; and

FIG. 9 shows a micrograph of terraced multilayers formed using an embodiment of the process of the present disclosure.

### DETAILED DESCRIPTION OF THE DISCLOSURE

### (I) Definitions

The term “substrate” as used herein refers to any substrate in which the surface can be coated with a block copolymer. Examples of substrates include, but are not limited to, silicon, germanium, other semiconductors, metals, glass, and plastic films.

The term “copolymer” as used herein refers to a polymer comprising two or more chemically-distinct monomeric subunits. These monomeric subunits are covalently attached to one another in a single polymer chain.

The term “block copolymer” as used herein refers to a copolymer comprising two or more different types of monomeric subunits, wherein the monomeric subunits are grouped into blocks containing only one type of monomeric subunit. These blocks are covalently attached to other blocks containing different subunits in the same polymer chain, and the monomeric subunits of the block copolymer undergo phase segregated arrangement as a result of the affinity of the monomeric subunits to organize with similar monomeric subunits.

The term “diblock copolymer” as used herein refers to a block copolymer in which there are only two different types of monomeric subunits.

The term “functional groups” as used herein refers to chemical moieties present in the polymer subunits of the block copolymer and which may be able to bind to metal ions. Examples of functional groups include, but are not limited to, pyridyl and pyridyl derivatives which bind to metal salts. Accordingly, the metal salts bind to the functional groups in the block copolymer domains formed by the block copolymer. In an embodiment, after removal of the block copolymer from the substrate and reduction of the metal salt, the metal nanostructures remain in the shape of the block copolymer domains.

The term “(C₁-C₆)-alkyl” as used herein means straight and/or branched chain, saturated alkyl radicals containing from one to six carbon atoms and includes methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like.

The term “halo” us used herein means any of the halogen atoms fluorine, chlorine, bromine and iodine.

The term “contacting” as used herein refers to the intimate contact of a particular reagent with a specific substrate. In an embodiment, the term contacting refers to the intimate contact of a block copolymer with the surface of the substrate such that a film of block copolymer is applied to the substrate. In an embodiment, the block copolymer is applied as a neat solution, or is applied with a solvent, such as tetrahydrofuran. In another embodiment, the term contacting refers to the intimate contact of the block copolymer-coated substrate with a metal salt, such that the metal ions bind to the block copolymer features formed by phase segregated arrangement of the block copolymer. In an embodiment, a first metal salt is contacted with the block copolymer-coated substrate such that the block copolymer features close to the exposed surface of the block copolymer-coated substrate are loaded with the metal ions. In another embodiment, a second metal salt is subsequently contacted with the block copolymer-coated substrate such that the block copolymer features closer to the surface of the substrate (or further removed from the exposed surface) become loaded with the metal ions.

The term “phase-segregated arrangement” as used herein refers to the segments of a block copolymer and their characteristic of self-organizing into thermodynamically favourable positions or conformations as a result of hydrophobic and hydrophilic or other molecular interactions in the polymer blocks (e.g., hydrophobic components will organize together, and hydrophilic components will organize together).

The term “layer” as used herein, such as a first or second layer, refers to a distinct layer comprising organized nanostructures as a result of phase-segregated arrangement of the block copolymer. Accordingly, there is no specific barrier between adjacent layers. Each layer is defined by the presence of nanostructures contained in the layer.

The term “nanostructures” as used herein refers to nanoscale features or shapes, such as, but not limited to, micelles, cylinders, nanowires, nanolines, nanorods, and lamellae. In one embodiment, nanostructures comprise various materials, including block copolymers, metals, and metal oxides. Examples of nanostructures include, but are not limited to, block copolymer domains, metal nanoparticles, and metal nanolines (or metal cylinders). Nanostructures may be arranged in a disordered fashion or may be arrayed in an orderly fashion.

The term “block copolymer pattern” as used herein refers to the organized pattern of nanostructures which are formed from the particular blocks as a result of the phase-segregated arrangement of the block copolymer. Accordingly, in an embodiment, the block copolymer is segregated into periodically-spaced nanodots in the layers. In another embodiment, the block copolymer pattern comprises nanolines.

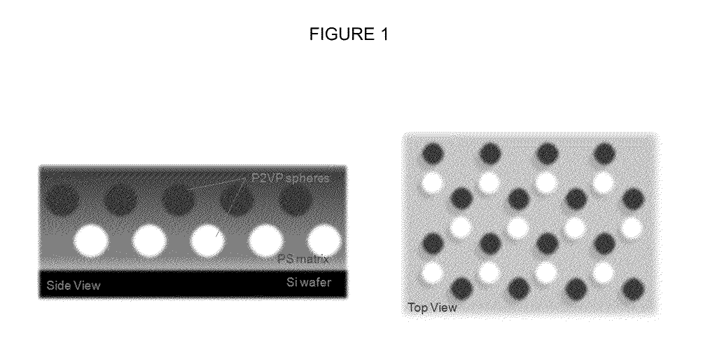

The term “metallic nanostructure array” as used herein refers to an organized pattern of metallic nanostructures on the surface of a substrate. In an embodiment, the metallic nanostructures form arrangements such as, but not limited to, a hexagonal lattice (as seen schematically in FIG. 1) or parallel wires. The arrangement of the metallic nanostructures are templated from the block copolymer pattern, and accordingly, will depend on the nature of the block copolymer. Further, the density of nanostructures on the substrate will also be dependent upon the nature of the block copolymer that is contacted with the substrate.

The terms “nanodots” or “nanolines” as used herein refer to nanostructures which are in the shapes of dots or particles (nanoparticles), or cylinders or wires, respectively.

The term “density” as used herein refers to the quantity of nanostructures, such as nanoparticles or nanocylinders per unit area of substrate. In one embodiment with respect to nanocylinders, it also refers to the number of nanocylinders per unit length of the substrate in a direction along the substrate perpendicular to the nanocylinders.

The term “metal salt” as used herein refers to any metallic salt in which the metal ions are able to diffuse through a block copolymer and bind to the block copolymer domains. Examples of metal salts include, but are not limited to, CoCl₂, ZnCl₂, Na₂PtCl₄, Na₂PdCl₄, RhCl₃, AgNO₃ or HAuCl₄. It will be understood that when the term metal salt is used in the context of a first and/or second metal salt, the BCP-coated substrate is first contacted with a first metal salt, and subsequently, contacted with a second metal salt.

The term “metal ion” as used herein refers to the charged metal atom of the metal salt. Accordingly, examples of metal ions include, but are not limited to, Co²⁺, Zn²⁺, PtCl₄²⁻, PdCl₄²⁻, Rh³⁺, Ag⁺ or AuCl₄⁻.

The term “galvanic displacement” as used herein refers to the reaction and reduction of metal ions, and subsequently, the deposition of the corresponding metal onto the substrate, and after removal of the block copolymer, forms a metallic nanostructure array.

The term “treating the substrate” to remove the block copolymer as used herein refers to any method for the removal or etching away of the block copolymer on the substrate, leaving the metallic nanostructure array on the substrate. In an embodiment, oxygen plasma is used to remove the block copolymer from the substrate. In another embodiment, when galvanic displacement is used to deposit the metal ions, the substrate is contacted with an organic solvent, such as toluene or THF, to remove the block copolymer.

### (II) Method of the Disclosure

It has now been determined that the density of nanostructures in a block copolymer pattern on a substrate is increased by increasing the thickness of the film of block copolymer that is applied to the substrate.

In an embodiment, the thickness of the block copolymer film applied to the substrate correlates to the concentration of the block copolymer in a solution. Accordingly, in an embodiment, a copolymer having a lower concentration in a solution will have a lower thickness, whereas a copolymer with a higher concentration in solution will have a comparatively higher thickness.

Accordingly, the present disclosure relates to a method of forming a block copolymer pattern on a substrate, the method comprising:
contacting the substrate with a block copolymer under conditions for a phase-segregated arrangement of the block copolymer and for at least a first layer and a second layer to be formed on the substrate, the first and second layers comprising a block copolymer pattern comprising nanostructures.

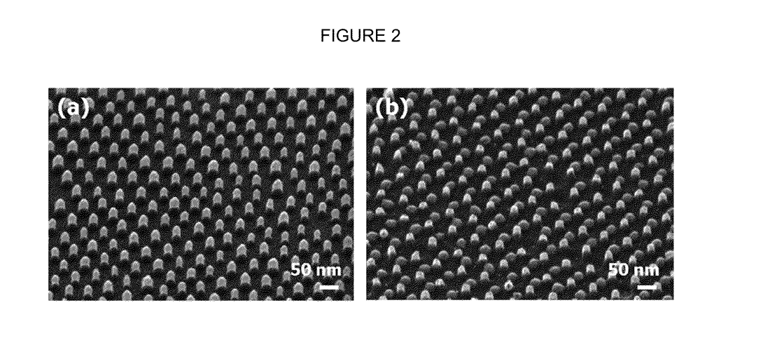

In another embodiment of the disclosure, the nanostructures in the first layer are interstitially spaced apart from the nanostructures in the second layer. In an embodiment, metallic nanoparticle arrays templated from block copolymer patterns is shown in FIG. 2. In FIG. 2a, a metallic nanoparticle array is shown that was templated from a block copolymer pattern comprising a single layer of nanostructures, whereas in FIG. 2b, a metallic nanoparticle array templated from a block copolymer pattern comprising two layers is shown. It is seen in FIG. 2b, that the nanostructures templated from the second layer is laterally offset from the first set of nanostructures and incorporated in the metallic nanoparticle array interstitially.

In a further embodiment, at least three layers comprising nanostructures are formed on the substrate. In an embodiment, the nanostructures formed in each layer are interstitially spaced apart from the nanostructures in each adjacent layer. It will be understood by those skilled in the art that the nanostructures will, in an embodiment, assume the lowest energy state, and in most cases successive layers will be laterally offset. In an embodiment, the third layer will be directly above the first layer. In an embodiment, the third layer will be offset from both the first and second layers

In another embodiment, the block copolymer pattern has a nanostructure density greater than that of a single layer of block copolymer features. In an embodiment, using the block copolymer PS(125k)-b-P2VP(58.5k) (the number after each block denotes the molecular weight of that block in g/mol), for instance, leads to hexagonal nanodots spaced 66 nm apart for a single layer which corresponds to a nanostructure density of 265/μm². For a double layer of nanostructures, the spacing is reduced to about 38 nm and the nanostructure density is increased to about 530/μm².

In another embodiment, the nanostructure density on the substrate is between 50 nanostructures/μm² and 200/μm², optionally between 150/μm² and 1500/μm², optionally between 400/μm² and 1200/μm².

In another embodiment of the disclosure, the areal nanostructure spacing (for example, the spacing between adjacent metallic nanostructures, after the block copolymer has been removed) is between 1 nm and 500 nm, optionally between 10 nm and 100 nm, optionally between 20 nm and 60 nm, optionally between 25 nm and 50 nm. In another embodiment, the nanostructure spacing is less than about 40 nm.

In another embodiment, the block copolymer pattern has a nanostructure density based on the variety of block copolymer utilized and the arrangement of the block copolymer features. Average areal distances between adjacent nanostructures for several types of block copolymers are shown below in the table:

| | Single Layer | Single | Double Layer | Double |
|---|---|---|---|---|
| | Nano- | Layer | Nano- | Layer |
| Block | particles | Nano- | particles | Nano- |
| Copolymer | (Dots) | Lines | (Dots) | Lines |
| PS(20k)-b- | 55 nm | | 32 nm | |
| P4VP(19k) | | | | |
| PS(48.5k)-b- | 72 nm | | 42 nm | |
| P2VP(70k) | | | | |
| PS(109k)-b- | 107 nm | | 62 nm | |
| P4VP(33.5k) | | | | |
| PS(125k)-b- | 66 nm | 62 nm | 38 nm | 31 nm |
| P2VP(58.5k) | | | | |
| PS(190k)-b- | 165 nm | | 110 nm | |
| P2VP(190k) | | | | |

In another embodiment, the nanostructures of the block copolymer pattern comprise hexagonally-arranged nanodots, or nanolines such as nanocylinders. In a further embodiment, a block copolymer pattern consisting of hexagonally arranged nanostructures is used as a template to form a hexagonal metallic nanoparticle array (as seen in FIG. 1). In another embodiment, nanolines in the block copolymer pattern are used as a template to form nanowires or nanocylinders in the metallic nanostructure array.

In another embodiment, the nanostructures of the block copolymer pattern comprise nanodots such as spherical micelles, or nanolines such as nanocylinders, wherein the nanocylinders are horizontally oriented. In another embodiment, the nanostructures comprise lamellar structures, thin sheets which periodically alternate in a direction parallel to the substrate. In a further embodiment, a lamellar block copolymer pattern is used as a template to form nanowires or nanolines in the metallic nanoparticle array.

In another embodiment of the disclosure, the nanostructures which form in the block copolymer pattern are controlled by manipulating the ratio of the blocks in a block copolymer. For example, in an embodiment, copolymers with a smaller ratio of PVP (polyvinylpyridine) to PS (polystyrene) are more likely to form nanodots, such as spherical micelles, while copolymers with a larger ratio (i.e., closer to 1:1) are more likely to form nanolines, such as nanocylinders. In another embodiment, if a copolymer has significantly more PVP than PS, then it is the PS component that will form spherical micelles within a PVP matrix, and the resulting metallized nanostructure array comprises a matrix of metal with an array of holes.

In an embodiment, the thickness of the block copolymer film applied to the substrate correlates to the concentration of the block copolymer in a solution contacting the substrate. Accordingly, in an embodiment, a block copolymer having a lower concentration in a solution will have a lower thickness, whereas a block copolymer with a higher concentration in a solution will have a comparatively higher thickness. In an embodiment, a sufficient amount of a block copolymer is applied to the substrate for phase-segregated arrangement of the block copolymer, such that at least a first layer and a second layer are formed on the substrate, wherein nanostructures are present in each of the layers, and the nanostructures comprise a block copolymer pattern, which is used as a template to form, for example, a metallic nanoparticle array. Accordingly, the sufficient amount of the block copolymer will form a first layer comprising nanostructures, and at least a second distinct layer also comprising nanostructures. In an embodiment, the nanostructures in each layer will self-organize into thermodynamically favourable positions, and accordingly, in an embodiment, the nanostructures in a particular layer will be laterally offset from the nanostructures in each adjacent layer (as seen in FIG. 1).

In another embodiment, the thickness of the block copolymer layer is controlled by the concentration of the block copolymer applied in a coating solution to the substrate. In an embodiment, the block copolymer is dissolved in a suitable organic solvent such as toluene, THF, chlorobenzene, or any other solvent which solubilizes the block copolymer, at a concentration of between 0.1 wt % and 5 wt %, 0.5 wt % and 3 wt %, suitably between 1.0 wt % and 2.5 wt %, optionally 2.0 wt %.

In an embodiment, the molecular weight of the first block of the block polymer is between 5,000 and 2,000,000, optionally between 75,000 and 175,000, optionally between 100,000 and 150,000, optionally 125,000 g/mol. In an embodiment, the first block of the block copolymer comprises polystyrene and/or polystyrene derivatives. In another embodiment, the molecular weight of the second block of the block copolymer is between 5,000 and 2,000,000, optionally between 40,000 and 80,000, optionally between 45,000 and 60,000, optionally 58,500 g/mol. In another embodiment, the second block of the block copolymer comprises poly-2-vinylpyridine or poly-4-vinylpyridine.

In another embodiment of the disclosure, the block copolymer is spin-coated on the substrate. Accordingly, for example, in an embodiment, a 2.0 wt % solution of the block copolymer in toluene is spin cast at a speed of between 500 rpm and 7,000 rpm, optionally between 2,000 rpm and 6,000 rpm, optionally between 3,000 rpm and 5,000 rpm, optionally 4,000 rpm, after an acceleration of between 4,000 rpm/s and 10,000 rpm/s, optionally between 5,000 rpm/s and 9,000 rpm/s, optionally between 6,000 rpm/s and 8,000 rpm/s, optionally between 7,500 rpm/s and 8,000 rpm/s, optionally 7,700 rpm/s. In an embodiment, under the conditions for the phase-segregated arrangement, the thickness of the block copolymer coated on the substrate is between 20 nm and 150 nm, optionally between 40 nm and 120 nm, optionally between 60 nm and 100 nm, optionally between 65 nm and 80 nm, optionally between 65 nm and 70 nm, optionally 70 nm. In another embodiment, the thickness is between 60 nm and 90 nm, optionally 90 nm.

In an embodiment, the block copolymer pattern comprises a first layer and second layer, each layer comprising nanostructures. In another embodiment, the block copolymer pattern comprises, in addition to a first and a second layer, a third layer, each layer comprising nanostructures. In a further embodiment, the block copolymer pattern is used as a template to form a metallic nanostructure array.

In an embodiment, phase-segregated arrangement of the block copolymer resulting in at least a first and second layer, results in a three-dimensional block copolymer pattern throughout the layers.

In an embodiment, the phase-segregated arrangement of the block copolymer pattern is performed by annealing the BCP-coated substrate. In an embodiment, the annealing process is accomplished by a heat treatment or by exposure to an appropriate solvent vapor, such as toluene, tetrahydrofuran or xylene, to swell the BCP film on the substrate, which helps form thermodynamically stable nanostructures and/or patterns. In an embodiment, the BCP-coated substrate is annealed using tetrahydrofuran vapor. After spin coating of the BCP onto the substrate, the BCP phase-segregates into an arrangement of nano-dots (although highly disordered), which is a thermodynamically unstable arrangement relative to other more stable nanostructures or patterns such as nanolines or nanocylinders. In one embodiment, the degree of swelling of the BCP on the substrate is directly related to the amount of solvent that has been absorbed, or penetrated, into the film. Accordingly, as the solvent concentration of the film increases during solvent-assisted annealing, so does the mobility of the BCP, allowing the BCP to self-assemble into a more thermodynamically favored configuration. As the solvent concentration increases, the BCP chains have greater mobility and form more stable nanostructures, such as nanocylinders or nanolines parallel to the substrate surface. When the amount of solvent is less, the BCP has less mobility, and therefore rearranges locally to form higher-ordered nano-dot patterns than the as-deposited patterns. It will be understood that different polymers will possess different thermodynamic equilibria with respect to the nanostructures that the polymer forms upon annealing, and will form whatever is their energetically-favoured arrangement. The thermodynamically-favored arrangement may be predicted with the aid of a phase diagram, which takes into account factors such as the block lengths, solvent, polymer concentration, and temperature.

In another embodiment, after the solvent-assisted annealing, the film is then treated to remove and/or dry the solvent from the BCP film. In one embodiment, this relaxation rate (relaxed from the swelling) is performed at different rates depending upon how quickly the solvent is removed (dried or evaporated) from the BCP film.

In an embodiment of the disclosure, the block copolymer is a diblock copolymer. In a further embodiment, the diblock copolymer comprises functional groups that bind to the metal salt. It will be understood by those skilled in the art that functional groups comprise any moiety within the nanostructures that is able to bind to a metal ion. For example, the functional group comprises a pyridyl moiety which is able to bind metal ions. In another embodiment, the functional group is any functional group comprising at least one heteroatom, such as N, P and/or O that binds to the metal.

In another embodiment, one block of the diblock copolymer comprises polymethylmethacrylate or polydimethylsiloxane. In another embodiment, one block of the diblock copolymer comprises polymethylmethacrylate.

In another embodiment of the disclosure, the block copolymer comprises polystyrene-block-polyvinylpyridine (PS-b-PVP), polystyrene-block-polyethyleneoxide (PS-b-PEO), polyethyleneoxide-block-polyisoprene (PEO-b-PI), polyethyleneoxide-block-polybutadiene (PEO-b-PBD), polyethyleneoxide-block-polymethylmethacrylate (PEO-b-PMMA), polystyrene-block-polymethylmethacrylate (PS-b-PMMA), polystyrene-block-polydimethylsiloxane (PS-b-PDMS), polyethyleneoxide-block-polyvinylpyridine (PEO-b-PVP), polystyrene-block-polymethylmethacrylate (PS-b-PMMA), polyvinylpyridine-block-polymethylmethacrylate (PVP-b-PMMA), polyethyleneoxide-block-polyethylethylene (PEO-b-PEE), polystyrene-block-polybutadiene (PS-b-PBD), styrene-isoprene-styrene (SIS), or polybutadiene-block-polyvinylpyridine (PBD-b-PVP). In another embodiment, the block copolymer comprises polystyrene-block-poly-2-vinyl-pyridine (PS-b-P2VP), polystyrene-block-poly-4-vinyl-pyridine (PS-b-P4VP), polystyrene-block-polymethylmethacrylate (PS-b-PMMA) or polystyrene-block-polydimethylsiloxane (PS-PDMS). In another embodiment, the disclosure also comprises block copolymer films including diblock, triblock and multiblock copolymers or blends of several block copolymers.

In another embodiment of the disclosure, the diblock copolymer is a polymer of the formula (I):

A-B (I)

wherein A is a repeating polymeric monomer unit of the formula (II)

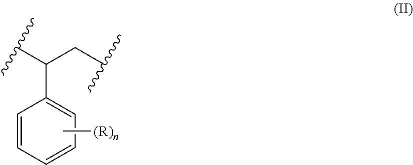

wherein each R is independently or simultaneously selected from H, halo, (C₁-C₆)-alkyl, —O—(C₁-C₆)-alkyl or fluoro-substituted-(C₁-C₆)-alkyl,
n is 1, 2, 3, 4 or 5; and
B is a repeating polymeric monomer unit of the formula (III)

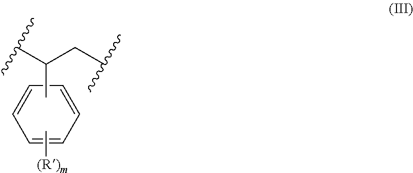

wherein each R′ is independently or simultaneously selected from H, halo, (C₁-C₆)-alkyl, —O—(C₁-C₆)-alkyl or fluoro-substituted-(C₁-C₆)-alkyl, and
m is 1, 2, 3 or 4.

In another embodiment, A is

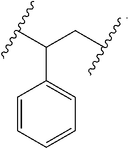

In a further embodiment, B is

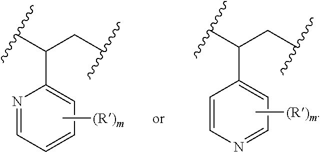

wherein each R′ is independently or simultaneously selected from H, halo, (C₁-C₆)-alkyl, —O—(C₁-C₆)-alkyl or fluoro-substituted-(C₁-C₆)-alkyl, and m is 1, 2, 3 or 4. In another embodiment, B is

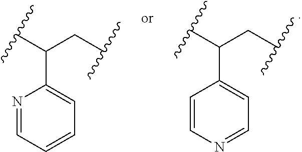

In another embodiment of the disclosure, the substrate comprises silicon, GaAs, Ge, another semiconductor, a metal, indium tin oxide, or a plastic. In an embodiment, the substrate is any surface which is flat or level and unreactive towards the block copolymer.

In another embodiment, there is also included a use of the block copolymer pattern to form a metallic nanostructure array wherein the use comprises:

(i)

(a) contacting the block copolymer-coated substrate with a metal salt comprising metal ions under conditions for the metal ions to bind to the block copolymer domains; and

(b) subsequently treating the substrate obtained in (a) to reduce the metal ions to metal and to remove the block copolymer from the substrate to form a metallic nanostructure array corresponding to the block copolymer pattern; or

(ii)
(a) treating the block copolymer-coated substrate with a metal salt under conditions for the galvanic displacement and deposition of the metal, and
(b) subsequently removing the block copolymer to form a metallic nanostructure array corresponding to the block copolymer pattern.

In a further embodiment of the disclosure, the block copolymer-coated substrate is contacted with a first metal salt and subsequently contacted with a second metal salt. It will be understood by those skilled in the art that, in an embodiment, when more than one metal salt is used, functional groups near the polymer surface are more likely to be loaded with metals from the first metal salt, while functional groups near the substrate are more likely to be saturated with metals from the second metal salt. Accordingly, in such an embodiment, for example, when a block copolymer forms layers of hexagonal nanodots, a hexagonal lattice of metal nanoparticles is produced wherein the composition of the individual nanoparticles alternates across the substrate. In another embodiment, the block copolymer-coated substrate is contacted with a first metal salt and subsequently contacted with a second metal salt, a third metal salt and, optionally, a fourth metal salt.

In another embodiment, the metal salt is CoCl₂, ZnCl₂, Na₂PtCl₄, Na₂PdCl₄ RhCl₃, AgNO₃ or HAuCl₄. In a further embodiment, the metal ion is Co²⁺, Zn²⁺, Rh³⁺, Ag⁺, PtCl₄²⁻, PdCl₄²⁻ or AuCl₄⁻. It will be understood by those skilled in the art, that in an embodiment, the metal ions of the metal salt bind to the functional groups within the block copolymer nanostructures, and accordingly, form metal-loaded nanostructures. Accordingly, after removal of the block copolymer from the substrate, a metallic nanostructure array remains on the substrate.

In another embodiment, the substrate is treated with plasma, such as oxygen plasma, to remove the block copolymer from the substrate. In an embodiment, the metal ions are reduced during the plasma process to form the metallic nanostructure array.

In another embodiment, galvanic displacement is used to form the metallic nanostructure array. In an embodiment, galvanic displacement comprises an electrochemical reaction in which a sufficiently oxidizing metal ion is spontaneously reduced at a semiconductor interface (see Chem. Mater. 2007, 19, 5090-5101, herein incorporated by reference). Metal salts are localized near functional groups, such as the pyridyl groups on polyvinylpyridine (PVP), and directly interact with the semiconductor substrate at locations of high PVP concentration. In an embodiment, the metal is Ag, Cu, Au, Pt or Pd. It will be understood by a person skilled in the art that when galvanic displacement is used with metals, such as gold or silver, the reaction directly produces metal nanostructures, rather than first having to complex a metal salt to the block copolymer (such as polyvinylpyridine) and then reducing to the metal during plasma processing. In another embodiment, hydrofluoric acid is used in the galvanic displacement reaction to assist the displacement process. After galvanic displacement, soaking the substrate in an organic solvent (like toluene or THF) removes the polymer from the substrate. In a further embodiment, the block copolymer layer in direct contact with the substrate (or any other layers beneath the layer exposed to the environment) is reduced to form metallic nanostructure arrays using galvanic displacement.

The present disclosure is also directed to a substrate comprising a metallic nanostructure array produced in accordance with the method of the present disclosure.

In another embodiment, the substrate comprising a metallic nanostructure array produced in accordance with the present disclosure is used as a nano-battery. For example, a battery comprises two different metals (with different work functions) immersed in an electrolyte solution. For a nanostructured battery, when contacting the two different metals with an electrolyte, a voltage will be generated between the metals. In another embodiment, the substrate comprising a metallic nanostructure array produced in accordance with the present disclosure is used as a solar cell.

The following non-limiting examples are illustrative of the present disclosure:

### EXAMPLES

### Reagents and Materials

Si(100) wafers were purchased from Addison Engineering. Asymmetric diblock copolymers of PS-b-P2VP were purchased from Polymer Source Inc., and Na₂PtCl₄ was obtained from Strem Chemicals. Toluene and THF were HPLC grade, purchased from Sigma-Aldrich. Hydrogen peroxide (Fisher, 30%), ammonium hydroxide (J. T. Bakers, 30%), and hydrochloric acid (J. T. Bakers, 36.5%) were used as received. High purity Millipore water (18 MΩ·cm, Barnstead Nanopure water) was used throughout the experiment, and plasma treatments were performed in a PlasmaLab μEtch reactive ion etch system.

### Example 1

### Generation of a Density Doubled Platinum Nanoparticle Array

A silicon wafer (<100>, n-type, B-doped, ρ=0.01-0.02 Ωcm) was diced into ˜1 cm² pieces and degreased in a methanol ultrasonic bath for 15 min followed by drying in a nitrogen stream. The substrates were then cleaned via a standard RCA clean: the diced wafers were first immersed in a hot solution of H₂O:NH₄OH:H₂O₂ (5:1:1) for 15 min and then rinsed with excess Millipore water. They were then immersed in a hot H₂O:HCl:H₂O₂ (6:1:1) solution for 15 min and re-rinsed with excess Millipore water. Following this cleaning procedure, the wafers were visibly hydrophilic. Water on the surface was immediately removed with a stream of nitrogen before polymer spin-coating.

The block copolymer polystyrene (PS-125k)-b-poly-2-vinylpyridine (P2VP-58.5 k) was dissolved in toluene at 70° C. to make 1 wt %-2 wt % solutions and allowed to cool to room temperature. A volume of 10 μL of the polymer solution was then dropped onto the cleaned Si substrate and spin coated at 4000 rpm. The as-spun thin films were then annealed for 24 hours by placing them in an enclosed chamber at room temperature in the presence of tetrahydrofuran (THF). The films were then removed from the chamber and allowed to dry under ambient conditions, forming a block copolymer pattern.

The wafer containing the block copolymer pattern was then immersed in 10 mM Na₂PtCl₄/0.9% HCl (aq) solution for 12 h. After metal deposition, the sample was thoroughly rinsed with water and dried under a nitrogen stream. Oxygen plasma in a Microetch reactor was employed to remove the polymer and reduce the metal ions (conditions: 50 mtorr, 50 sccm O₂, RF power 30 W, and time 30 s).

### Discussion

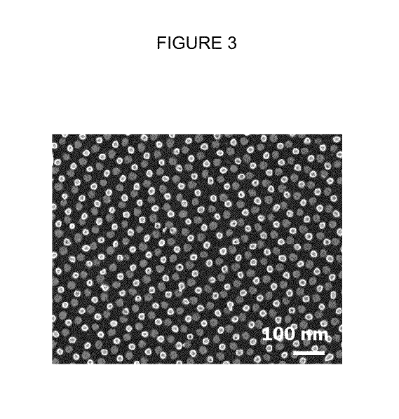

In an embodiment, the anneal cycle of the thin films in an enclosed chamber with THF helps with the formation of an organized hexagonal block copolymer pattern. The pattern is shown in FIG. 3. For this particular block copolymer, the hexagonal pattern is the lowest energy state, so the block copolymer attempts to organize itself into that state. In most cases though, the polymer becomes “frozen” after the spin-coating process: the process happens too quickly for the polymer to reach its minimum energy (i.e., hexagonal) state. In an embodiment, to increase the order, the sample is annealed (essentially “melting” the polymer and allowing it to better organize itself). “Melting” happens, for example, thermally (when a polymer is heated, it starts to flow), or with solvents (solvents penetrate into the sample, making it flow).

### Example 2

### Generation of a Density-Doubled Array of Platinum Nanolines

A silicon wafer (<100>, n-type, B-doped, 1-10 ohmcm) was diced into ˜1 cm² pieces and degreased in a methanol ultrasonic bath for 15 min followed by drying in a nitrogen stream. The substrates were then cleaned via a standard RCA clean: the diced wafers were first immersed in a 80° C. solution of H₂O:NH₄OH:H₂O₂ (5:1:1) for 15 min and then rinsed with excess Millipore water. They were then immersed in a hot H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin-coating.

The block copolymer PS(125k)-b-P2VP(58.5 k) was dissolved in toluene at 70° C. to make 1 wt %-2 wt % solutions and allowed to cool to room temperature. A volume of 10 μL of the polymer solution was then dropped onto the cleaned Si substrate and spin-coated at 4000 rpm for 40s. The as-spun thin films were then annealed for 72 hours by placing them in an enclosed chamber at room temperature in the presence of tetrahydrofuran (THF). In an embodiment, this anneal cycle helps with the formation of an organized block copolymer pattern of parallel cylinders. The films were then removed from the chamber and allowed to dry under ambient conditions.

The polymer-coated wafer was then immersed in 10 mM Na₂PtCl₄/0.9% HCl (aq) solution for 3 h to metal-load the P2VP portion of the block copolymer with platinum ions. After metal deposition, the sample was thoroughly rinsed with water and dried under a nitrogen stream.

Oxygen plasma in a Microetch reactor was employed to remove the polymer and reduce the metal ions (conditions: 50 mtorr, 50 sccm O₂, RF power 30 W, and time 35 s) followed by an argon plasma (conditions: 100 mTorr, 50 sccm Ar, RF power 50 W, and time 5 s).

### Discussion

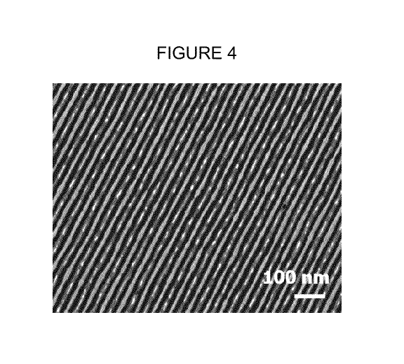

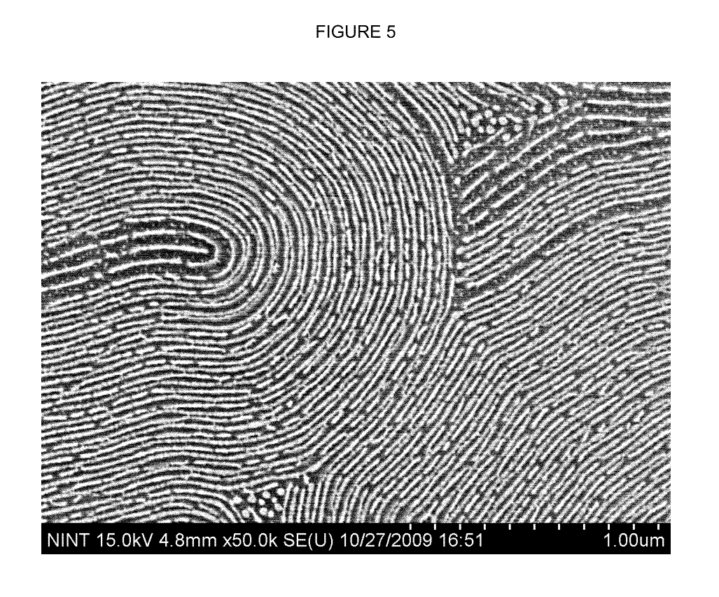

In an embodiment, the anneal cycle of the thin films in an enclosed chamber with THF for 72 hours helps with the formation of an organized pattern of parallel nanolines. The pattern is shown in FIGS. 4 and 5.

### Example 3

### Generation of a Density-Doubled Array of Palladium Nanolines

A silicon wafer (<100>, n-type, B-doped, 1-10 Ωcm) was diced into ˜1 cm² pieces and degreased in a methanol ultrasonic bath for 15 min followed by drying in a nitrogen stream. The substrates were then cleaned via a standard RCA clean: the diced wafers were first immersed in a 80° C. solution of H₂O:NH₄OH:H₂O₂ (5:1:1) for 15 min and then rinsed with excess Millipore water. They were then immersed in a hot H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin-coating.

The block copolymer PS(125k)-b-P2VP(58.5 k) was dissolved in toluene at 70° C. to make 1 wt %-2 wt % solutions and allowed to cool to room temperature. A volume of 10 μL of the polymer solution was then dropped onto the cleaned Si substrate and spin coated at 4000 rpm for 40s. The as-spun thin films were then annealed for 72 hours by placing them in an enclosed chamber at room temperature in the presence of tetrahydrofuran (THF). In an embodiment, this anneal cycle helps with the formation of an organized block copolymer pattern of parallel nanolines. The films were then removed from the chamber and allowed to dry under ambient conditions.

The polymer-coated wafer was then immersed in 10 mM Na₂PdCl₄/0.9% HCl (aq) solution for 12 h to metal-load the P2VP portion of the block copolymer with palladium ions. After metal deposition, the sample was thoroughly rinsed with water and dried under a nitrogen stream.

Oxygen plasma in a Microetch reactor was employed to remove the polymer and reduce the metal ions (conditions: 50 mtorr, 50 sccm O₂, RF power 30 W, and time 45 s.) followed by an argon plasma (conditions: 100 mTorr, 50 sccm Ar, RF power 50 W, and time 5 s).

### Example 4

### Generation of a Density-Doubled Array of Silver Nanolines

A silicon wafer (<100>, n-type, B-doped, 1-10 Ωcm) was diced into ˜1 cm2 pieces and degreased in a methanol ultrasonic bath for 15 min followed by drying in a nitrogen stream. The substrates were then cleaned via a standard RCA clean: the diced wafers were first immersed in a 80° C. solution of H₂O:NH₄OH:H₂O₂ (5:1:1) for 15 min and then rinsed with excess Millipore water. They were then immersed in a hot H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin-coating.

The block copolymer PS(125k)-b-P2VP(58.5 k) was dissolved in toluene at 70° C. to make 1 wt %-2 wt % solutions and allowed to cool to room temperature. A volume of 10 μL of the polymer solution was then dropped onto the cleaned Si substrate and spin-coated at 4000 rpm for 40s). The as-spun thin films were then annealed for 72 hours by placing them in an enclosed chamber at room temperature in the presence of tetrahydrofuran (THF). In an embodiment, this anneal cycle helps with the formation of an organized block copolymer pattern of parallel nanolines. The films were then removed from the chamber and allowed to dry under ambient conditions.

The polymer coated wafer was then immersed in 0.1 mM AgNO₃/0.9% HF (aq) solution for 10 min to metal-load the P2VP portion of the block copolymer with silver ions. After metal deposition, the sample was thoroughly rinsed with water and dried under a nitrogen stream.

Oxygen plasma in a Microetch reactor was employed to remove the polymer and reduce the metal ions (conditions: 50 mtorr, 50 sccm O₂, RF power 30 W, and time 60 s) followed by an argon plasma (conditions: 100 mTorr, 50 sccm Ar, RF power 50 W, and time 5 s).

### Example 5

### Generation of a Density-Doubled Array of Copper Nanolines

A silicon wafer (<100>, n-type, B-doped, 1-10 Ωcm) was diced into ˜1 cm² pieces and degreased in a methanol ultrasonic bath for 15 min followed by drying in a nitrogen stream. The substrates were then cleaned via a standard RCA clean: the diced wafers were first immersed in a 80° C. solution of H₂O:HCl:H₂O₂ (5:1:1) for 15 min and then rinsed with excess Millipore water. They were then immersed in a hot H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin-coating.

The block copolymer PS(125k)-b-P2VP(58.5 k) was dissolved in toluene at 70° C. to make 1 wt %-2 wt % solutions and allowed to cool to room temperature. A volume of 10 μL of the polymer solution was then dropped onto the cleaned Si substrate and spin-coated at 4000 rpm for 40s). The as-spun thin films were then annealed for 72 hours by placing them in an enclosed chamber at room temperature in the presence of tetrahydrofuran (THF). In an embodiment, this anneal cycle helps with the formation of an organized block copolymer pattern of parallel nanolines. The films were then removed from the chamber and allowed to dry under ambient conditions.

The polymer-coated wafer was then immersed in 10 mM CuCl₂/0.9% HF (aq) solution for 10 min to metal-load the P2VP portion of the block copolymer with copper ions. After metal deposition, the sample was thoroughly rinsed with water and dried under a nitrogen stream.

Oxygen plasma in a Microetch reactor was employed to remove the polymer and reduce the metal ions (conditions: 50 mtorr, 50 sccm O₂, RF power 30 W, and time 60 s) followed by an argon plasma (conditions: 100 mTorr, 50 sccm Ar, RF power 50 W, and time 5 s).

### Example 6

### Determination of Block Copolymer Features Based on Degree of Swelling During Annealing

A silicon wafer (<100>, n-type, phosphorous-doped, 5-10 Ωcm resistivity, ˜500 μm thick) was diced into ˜100 mm² pieces and degreased in a methanol ultrasonic bath for 15 min followed by drying in a nitrogen stream. The substrates were then cleaned via a standard RCA clean: the diced wafers were first immersed in a 80° C. solution of H₂O:HCl:H₂O₂ (5:1:1) for 15 min and then rinsed with excess Millipore water. They were then immersed in a 80° C. solution of H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin coating.

The block copolymer PS(50k)-b-P2VP(16.5 k) was dissolved in toluene at 70° C. to make a 1 wt % solution and allowed to cool to room temperature. A volume of 10 μL of the polymer solution was then dropped onto the cleaned Si substrate and spin-coated at 2000 rpm for 40 s, giving a film thickness of 43 nm. The as-spun thin films were then annealed for between 20 to 40 minutes by placing them in an enclosed chamber at room temperature in the presence of 1 mL of liquid tetrahydrofuran (THF) in a trench next to the substrate. The progress of the annealing of the block copolymer was followed using in situ ellipsometry. The chamber was then opened in a controlled fashion to reduce the vapor pressure inside the chamber in a controlled fashion. Opening the chamber in a controlled fashion results in the film relaxing and returning to its original thickness. After the sample had returned to its original thickness, the sample was removed from the chamber.

The polymer-coated wafer was then immersed in 10 mM PtCl₂/0.9% HCl (aq) solution for 3 hours to metal-load the P2VP portion of the block copolymer with platinum ions. After metal deposition, the sample was thoroughly rinsed with water and dried under a nitrogen stream.

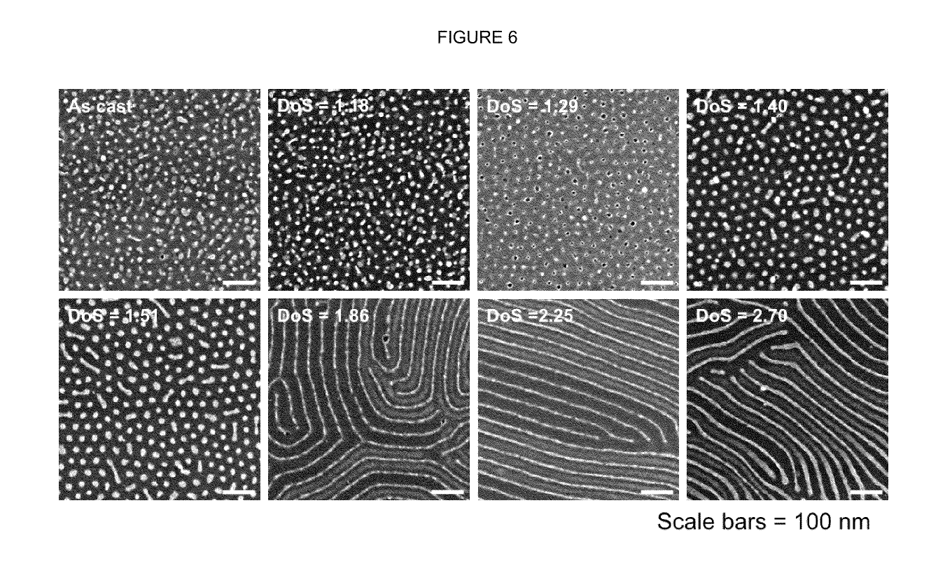

Oxygen plasma in a Microetch reactor was employed to remove the polymer and reduce the metal ions (conditions: 50 mtorr, 50 sccm O₂, RF power 30 W, and time 25 s). Scanning electron micrographs of the metal nanostructure patterns are shown in FIG. 6.

### Discussion

The degree of swelling (DoS) of the block copolymer pattern as measured by in situ ellipsometry tracks the status as the block copolymer anneals. The degree of swelling is the ratio of the thickness of the swelled polymer film vs. that of the unswelled polymer film. DoS values less than about 1.7 (as measured by in situ ellipsometry) lead to block copolymer features which are dots, rather than lines (or cylinders). Without being bound by theory, it is thought that certain block copolymers which are annealed with a degree of swelling of less than about 1.7 have insufficient mobility to allow for the reorganization into cylinders (when annealed using a solvent, such as THF) (as seen in FIG. 6). Block copolymers which are annealed with a degree of swelling of more than about 1.8 have sufficient mobility to allow for the reorganization into horizontal cylinders (also as seen in FIG. 6). Accordingly, FIG. 6 shows horizontal cylinders when the annealing of the block copolymers is performed with DoS values of 1.86, 2.25, and 2.70, while dots are formed at DoS values of 1.18, 1.29, 1.40, and 1.51.

### Example 7

### Determination of Block Copolymer Features Based on Annealing Time

Silicon wafers (<100>, n-type, phosphorous-doped, 5-10 Ωcm resistivity, ˜500 μm thick) were diced into ˜100 mm² pieces and degreased in a methanol ultrasonic bath for 15 min followed by drying in a nitrogen stream. The substrates were then cleaned via a standard RCA clean: the diced wafers were first immersed in a 80° C. solution of H₂O:HCl:H₂O₂ (5:1:1) for 15 min and then rinsed with excess Millipore water. They were then immersed in a 80° C. solution of H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin-coating.

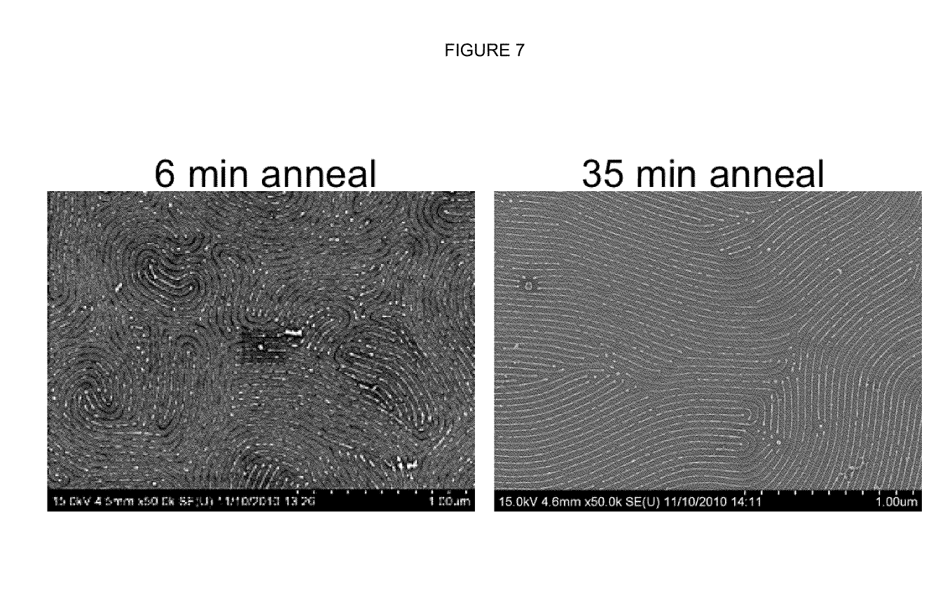

The block copolymer PS(50k)-b-P2VP(16.5 k) was dissolved in toluene at 70° C. to make a 1 wt % solution and allowed to cool to room temperature. A volume of 10 μL of the polymer solution was then dropped onto the cleaned Si substrate and spin coated at 2000 rpm for 40 s, giving a film thickness of 43 nm. The as-spun thin films were then annealed for 6 or 35 minutes by placing them in an enclosed chamber at room temperature in the presence of 1 mL or 2 mL of liquid tetrahydrofuran (THF). The THF was placed in different trenches next to the substrate depending on the rate of swelling desired. A larger exposed surface area of THF will cause the swelling rate to increase, thus shortening the time required to achieve a given degree of swelling. For a short, 6-minute anneal, 1 mL of THF was placed into a trench so that it had an exposed surface area of ˜150 mm². For a longer anneal (35 min), 2 mL of THF was placed into a trench so that it had an exposed surface area of ˜1500 mm². The progress of the annealing of the block copolymer was followed using in situ ellipsometry. Scanning electron micrographs are shown in FIG. 7.

The polymer-coated wafer was then immersed in 10 mM PtCl₂/0.9% HCl (aq) solution for 3 hours to metal-load the P2VP portion of the block copolymer with platinum ions. After metal deposition, the sample was thoroughly rinsed with water and dried under a nitrogen stream.

Oxygen plasma in a Microetch reactor was employed to remove the polymer and reduce the metal ions (conditions: 50 mtorr, 50 sccm O₂, RF power 30 W, and time 25 s).

### Discussion

As shown in FIG. 7, the transition from dots to horizontal cylinder block copolymer features occurred at DoS values of about 1.8. This example demonstrates that the DoS value is the determining factor between dot or line structures, and that the length of time of the anneal does not determine the structure type. What the time does affect, however, is the ordering of the structures. As shown in FIG. 7, given more time, the polymer arranges into higher-ordered structures.

### Example 8

### Determination of Block Copolymer Features Based on Relaxation Rate

A silicon wafer (<100>, n-type, phosphorous-doped, 5-10 Ωcm resistivity, ˜500 μm thick) was diced into ˜100 mm² pieces and degreased in a methanol ultrasonic bath for 15 min followed by drying in a nitrogen stream. The substrates were then cleaned via a standard RCA clean: the diced wafers were first immersed in a 80° C. solution of H₂O:HCl:H₂O₂ (5:1:1) for 15 min and then rinsed with excess Millipore water. They were then immersed in a 80° C. solution of H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin-coating.

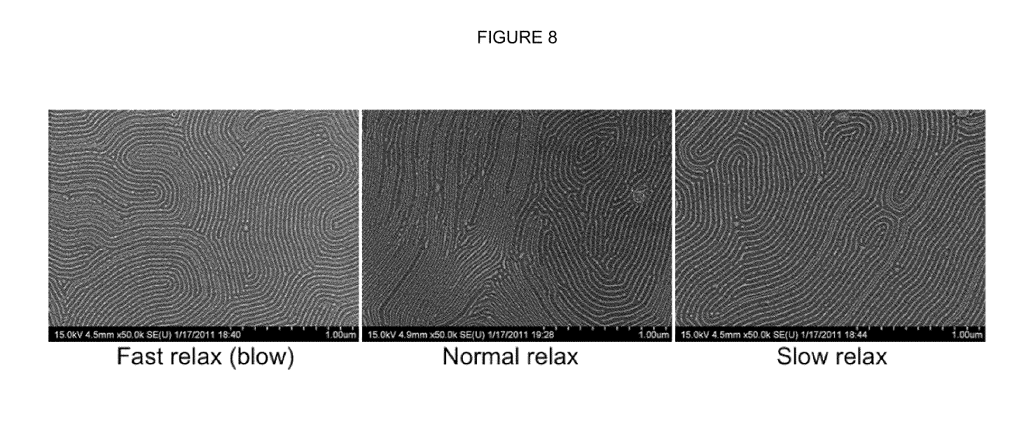

The block copolymer PS(50k)-b-P2VP(16.5 k) was dissolved in toluene at 70° C. to make a 1.8 wt % solution and allowed to cool to room temperature. A volume of 10 μL of the polymer solution was then dropped onto the cleaned Si substrate and spin-coated at 4000 rpm for 40 s, giving a film thickness of 55 nm. The as-spun thin films were then annealed for 40 minutes by placing them in an enclosed chamber at room temperature in the presence of 1 mL of liquid tetrahydrofuran (THF) (exposed surface area of ˜150 mm²). The progress of the annealing of the block copolymer was followed using in situ ellipsometry. Scanning electron micrographs are shown in FIG. 8.

For a fast relaxation rate, the chamber was opened, and air was immediately blown on the sample to induce rapid drying of the substrate. For normal relaxation, the chamber was opened to a certain position to allow for a moderate relaxation (the same position as used in Examples 6, 7 and 9). For the slow relaxation, the chamber was opened just a crack so that the relaxation would occur very slowly.

The polymer-coated wafer was then immersed in 10 mM PtCl₂/0.9% HCl (aq) solution for 3 hours to metal-load the P2VP portion of the block copolymer with platinum ions. After metal deposition, the sample was thoroughly rinsed with water and dried under a nitrogen stream.

Oxygen plasma in a Microetch reactor was employed to remove the polymer and reduce the metal ions (conditions: 50 mtorr, 50 sccm O₂, RF power 30 W, and time 25 s).

### Discussion

As shown in FIG. 8, the transition from dots to horizontal cylinder block copolymer features occurs at DoS values of about 1.8. This example demonstrates the effect of varying the relaxation rate on the structures. Across the range of conditions used, the relaxation rate did not affect the type of structures obtained, as lines were obtained in all three cases. The DoS value in this case was 2.0.

### Example 9

### Determination of Effect of Polymer Concentration, Spin Speed and Anneal Time

A silicon wafer (<100>, n-type, phosphorous-doped, 5-10 Ωcm resistivity, ˜500 μm thick) was diced into ˜100 mm² pieces and degreased in a methanol ultrasonic bath for 15 min followed by drying in a nitrogen stream. The substrates were then cleaned via a standard RCA clean: the diced wafers were first immersed in a 80° C. solution of H₂O:HCl:H₂O₂ (5:1:1) for 15 min and then rinsed with excess Millipore water. They were then immersed in a 80° C. solution of H₂O:HCl:H₂O₂ (6:1:1) solution for 15 min and re-rinsed with excess Millipore water. Following this cleaning procedure, the wafers were visibly hydrophilic; water on the surface was immediately removed with a stream of nitrogen before polymer spin-coating.

The block copolymer PS(50k)-b-P2VP(16.5 k) was dissolved in toluene at 70° C. to make 0.5 wt % to 1.8 wt % solutions and allowed to cool to room temperature. A volume of 10 μL of the polymer solution was then dropped onto the cleaned Si substrate and spin-coated at between 1000 rpm to 6000 rpm for 40 s, giving film thicknesses of 30 to 50 nm. The as-spun thin films were then annealed for 40 minutes by placing them in an enclosed chamber at room temperature in the presence of 1 mL of liquid tetrahydrofuran (THF) (−150 mm² exposed surface area). The progress of the annealing of the block copolymer was followed using in situ ellipsometry. Samples were then relaxed in a controlled fashion, metallized, and also subjected to a plasma treatment (same conditions as in Example 6).

### Discussion

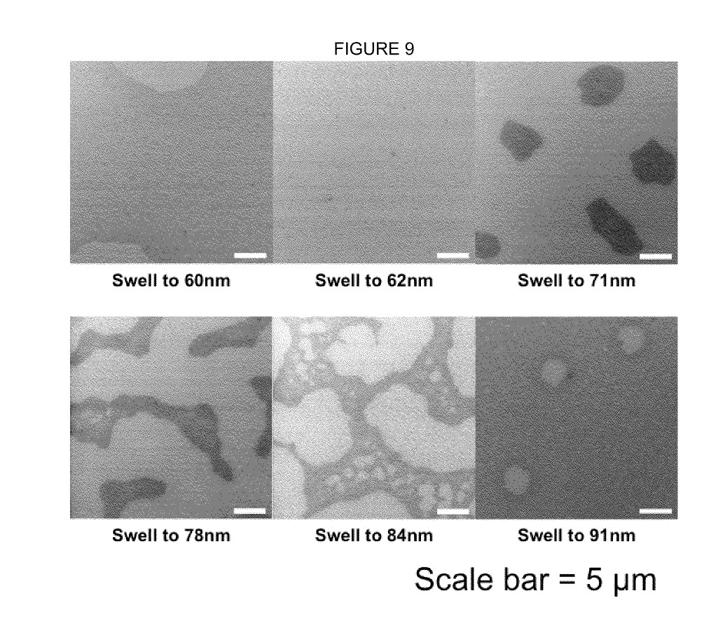

This example, as shown in FIG. 9, demonstrates the formation of terraces and layers across the wafer using film thicknesses of about 90 nm after the anneal period for PS(50k)-b-P2VP(16.5 k).

During swelling of the block copolymer exposed to THF vapor, terraces first appear and continue growing until they fill the entire substrate, at which point a double layer is formed over the entire substrate. As the film further swells, a new set of terraces corresponding to the formation of a third layer, grow and coalesce as well. The first terraces (corresponding to the second layer) appear at around 60 nm, and a full double layer is around 90 nm, at which point a second set of terraces (corresponding to a third layer) appear.

Examples 6-8 demonstrated how different annealing conditions affect the types of structures that are formed by the BCP. Example 9 shows that, as the film thickness increases, these structures must stack on top of each other (forming terraces and eventually whole layers). When two layers are formed, then metallizing both layers effectively doubles the (areal) density of metal features on the substrate.

We claim:

1. A method of forming a block copolymer pattern on a substrate, the method comprising:
contacting the substrate with a block copolymer under conditions for a phase-segregated arrangement of the block copolymer and for at least a first layer and a second layer to be formed on the substrate, the first and second layers comprising a block copolymer pattern comprising nanostructures.

2. The method according to claim 1, wherein the nanostructures in the first layer are interstitially spaced apart from the nanostructures in the second layer.

3. The method according to claim 1, wherein at least three layers comprising nanostructures are formed on the substrate.

4. The method according to claim 1, wherein the nanostructures of the block copolymer pattern comprise nano-dots, lamellae or nano-lines.

5. The method according to claim 1, wherein the block copolymer pattern has a nanostructure density and wherein the density is between 50 nanostructures/μm² and 2000/μm².

6. The method according to claim 1, wherein the spacing between adjacent nanostructures is between 1 nm and 500 nm.

7. The method according to claim 1, wherein the thickness of the block copolymer on the substrate is between 20 nm and 150 nm.

8. The method according to claim 1, wherein the block copolymer is a diblock copolymer.

9. The method according to claim 8, wherein the diblock copolymer comprises functional groups that bind to metal salts.

10. The method according to claim 9, wherein the diblock copolymer is a polymer of the formula (I):
A-B (I)
wherein A is a repeating polymeric monomer unit of the formula (II) 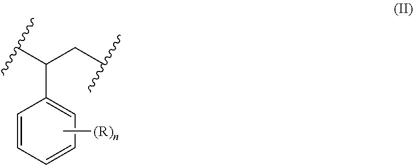
wherein each R is independently or simultaneously selected from H, halo, (C₁-C₆)-alkyl, —O—(C₁-C₆)-alkyl or fluoro-substituted-(C₁-C₆)-alkyl,
n is 1, 2, 3, 4 or 5; and
B is a repeating polymeric monomer unit of the formula (III) 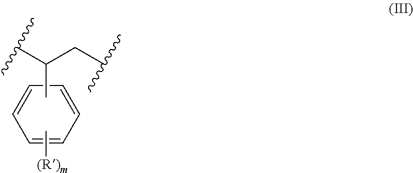
wherein each R′ is independently or simultaneously selected from H, halo, (C₁-C₆)-alkyl, —O—(C₁-C₆)-alkyl or fluoro-substituted-(C₁-C₆)-alkyl, and
m is 1, 2, 3 or 4.

11. The method according to claim 10, wherein A is

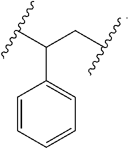

12. The method according to claim 10, wherein B is 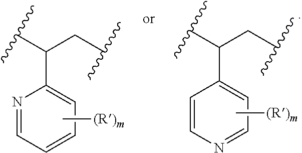
wherein each R′ is independently or simultaneously selected from H, halo, (C₁-C₆)-alkyl, —O—(C₁-C₆)-alkyl or fluoro-substituted-(C₁-C₆)-alkyl, and m is 1, 2, 3 or 4.

13. The method according to claim 12, wherein B is

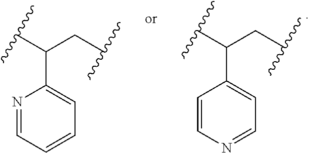

14. The method according to claim 8, wherein one of the blocks comprises polymethylmethacrylate or polydimethylsiloxane.

15. The method according to claim 1, wherein the substrate comprises silicon, GaAs, Ge, a semiconductor, a metal, indium tin oxide, or a plastic.

16. A method of forming a metallic nanostructure array comprising:
(i)
(a) contacting the block copolymer-coated substrate produced according to the method of claim 1 with a metal salt comprising metal ions under conditions for the metal ions to bind to the block copolymer domains; and
(b) subsequently treating the substrate obtained in (a) to reduce the metal ions and to remove the block copolymer from the substrate to form a metallic nanostructure array corresponding to the block copolymer pattern; or
(ii)
(a) treating the block copolymer-coated substrate produced according to the method of claim 1 with a metal salt under conditions for the galvanic displacement and deposition of the metal; and
(b) subsequently removing the block copolymer to form a metallic nanostructure array corresponding to the block copolymer pattern.

17. The method according to claim 16, wherein the block copolymer-coated substrate is contacted with a first metal salt and subsequently contacted with a second metal salt.

18. The method according to claim 16, wherein the metal salt is CoCl₂, ZnCl₂, Na₂PtCl₄, Na₂PdCl₄, RhCl₃, AgNO₃ or HAuCl₄.

19. The method according to claim 16, wherein the substrate is treated with oxygen plasma to remove the block copolymer from the substrate.

20. A substrate comprising nanostructures or nanoscale features produced in accordance with the method of claim 1.

21. A substrate comprising a metallic nanostructure array produced in accordance with the method of claim 16.
